(19) United States
(12) Patent Application Publication
(10) Pub. No.: US 2026/0222525 A1
(43) Pub. Date: Jul. 30, 2026

(54) METHOD OF DETERMINING COLOR CORRECTION MATRIX, COLOR CORRECTION METHOD AND ELECTRONIC DEVICE

(71) Applicant: SAMSUNG ELECTRONICS CO., LTD., Suwon-si (KR)

(72) Inventors: Jingyu FANG, Suzhou (CN); Hui SUN, Suzhou (CN); Qingliang MA, Suzhou (CN)

(73) Assignee: SAMSUNG ELECTRONICS CO., LTD., Suwon-si (KR)

(21) Appl. No.: 19/062,690

(22) Filed: Feb. 25, 2025

(30) Foreign Application Priority Data
Jan. 26, 2025 (CN) 202510125512.9

(51) Int. Cl. H04N 9/64

(52) U.S. Cl. CPC H04N 9/646

(57) ABSTRACT

A method of determining a color correction matrix may include: receiving a first reference image generated by photographing a first object in a first lighting condition using a reference camera; receiving a first image generated by photographing the first object in the first lighting condition using a first camera; calculating a first color correction matrix of the first camera using the first reference image, the first image, and a first reference color correction matrix of the reference camera, the first color correction matrix and the first reference color correction matrix corresponding to the first lighting condition; and correcting an actual image using the first color correction matrix.

### CROSS-REFERENCE TO RELATED APPLICATION

This U.S. non-provisional application claims priority under 35 USC § 119 to Chinese Patent Application No. 202510125512.9, filed on Jan. 26, 2025, in the Chinese National Intellectual Property Administration, the disclosure of which is herein incorporated by reference in its entirety.

### BACKGROUND

### 1. Field

The disclosure relates to a field of image process, and more particularly, to a method of determining a color correction matrix, a color correction method and an electronic device.

### 2. Description of Related Art

A color correction matrix (CCM) may be used for color correction in image process. An existing method of determining the color correction matrix comprises visually adjusting the color correction matrix by the tester using a tuning tool, such that an actual image, captured by a camera, that corrected by the color correction matrix approximates a standard image. However, adjusting the color correction matrix using the tuning tool is time-consuming (e.g., it may take several hours to determine a color correction matrix corresponding to one lighting condition).

Thus, there is a need for a method that can improve the efficiency of determining the color correction matrix.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present application provides a method of determining a color correction matrix, a color correction method and an electronic device, which may at least improve the efficiency of determining the color correction matrix.

According to one or more example embodiments, a method of determining a color correction matrix may include: receiving a first reference image generated by photographing a first object in a first lighting condition using a reference camera; receiving a first image generated by photographing the first object in the first lighting condition using a first camera; calculating a first color correction matrix of the first camera using the first reference image, the first image, and a first reference color correction matrix of the reference camera, the first color correction matrix and the first reference color correction matrix corresponding to the first lighting condition; and correcting an actual image using the first color correction matrix.

Compared to a scheme of determining a color correction matrix using a tuning tool, in the present application, the first color correction matrix of the first camera is calculated using the first reference image and the first reference color correction matrix of the reference camera, thereby improving the efficiency of determining the color correction matrix.

The calculating of the first color correction matrix corresponding to the first lighting condition of the first camera may include: determining the first color correction matrix such that a difference between the first image corrected using the first color correction matrix and the first reference image corrected using the first reference color correction matrix is minimized.

The determining of the first color correction matrix may include: correcting the first reference color correction matrix using a first correction term reflecting a first RGB matrix of the first image and a first reference RGB matrix of the first reference image to determine the first color correction matrix.

The method may further include: calculating a second color correction matrix of the first camera corresponding to a second lighting condition, by correcting a second reference color correction matrix of the reference camera corresponding to the second lighting condition, using a first correction term reflecting a first RGB matrix of the first image and a first reference RGB matrix of the first reference image. The second lighting condition may be different from the first lighting condition.

The first correction term may represent a product of a first transpose matrix, the first reference RGB matrix, and an inverse of a product of the first transpose matrix of the first RGB matrix and the first RGB matrix.

The method may further include: determining a reference spectral response function of the reference camera; determining a first spectral response function of the first camera; predicting a second reference image of the reference camera using the reference spectral response function, the second reference image corresponding to a second lighting condition; predicting a second image of the first camera using the first spectral response function, the second image corresponding to the second lighting condition; and calculating a second color correction matrix of the first camera using the second reference image, the second image, and a second reference color correction matrix of the reference camera, the second color correction matrix and the second reference color correction matrix corresponding to the second lighting condition. The second lighting condition may be different from the first lighting condition.

Compared to determining the color correction matrix corresponding to each lighting condition by the tuning tool, in the present application, reference images and images, corresponding to the remaining lighting conditions except the first lighting condition, of the reference camera and the first camera are predicted by using spectral response functions of the reference camera and the first camera and the remaining lighting conditions and color correction matrices, corresponding to the remaining lighting conditions, of the first camera is calculated using the predicted reference images and the images, which may reduce the time for photographing the first object in the remaining light conditions, thereby further improving the efficiency of determining the color correction matrix.

The reference spectral response function may be a polynomial matrix which uses a first reference RGB matrix of the first reference image as a variable.

A 1st-order coefficient matrix to a nth-order coefficient matrix of the polynomial matrix may be determined in an order from the 1st-order coefficient matrix to the nth-order coefficient matrix. An ith-order coefficient matrix of the polynomial matrix may be determined by: obtaining an updated polynomial matrix corresponding to the ith-order coefficient matrix; and determining the ith-order coefficient matrix, by using the updated polynomial matrix corresponding to the ith-order coefficient matrix and a camera response function. N may be an integer greater than 1, and i is an integer greater than or equal to 1 and less than or equal to n. An updated polynomial matrix corresponding to the 1st-order coefficient matrix may be obtained by setting a 2nd-order coefficient matrix to the nth-order coefficient matrix of an original polynomial matrix to a zero matrix. An updated polynomial matrix corresponding to an mth-order coefficient matrix may be obtained by substituting the previously determined 1st-order coefficient matrix to (m−1)th-order coefficient matrix into the original polynomial matrix and setting an (m+1)-order coefficient matrix to the nth-order coefficient matrix of the original polynomial matrix to the zero matrix, m being an integer greater than 1 and less than n. An updated polynomial matrix corresponding to the nth-order coefficient matrix may be obtained by substituting the previously determined 1st-order coefficient matrix to (n−1)th-order coefficient matrix into the original polynomial matrix. In the original polynomial matrix, the 1st-order coefficient matrix to the nth-order coefficient matrix may not be determined.

The camera response function may be based on a relationship between the first reference RGB matrix and a spectral reflectance matrix of the first object, a first spectral power distribution corresponding to the first lighting condition, and the reference spectral response function.

The calculating of the second color correction matrix may include: determining the second color correction matrix such that a difference between the second image corrected using the second color correction matrix and the second reference image corrected using the second reference color correction matrix is minimized.

The first lighting condition may represent a standard lighting condition in which illumination on each region of the first object is uniform.

The first object may be a standard color card.

According to one or more example embodiments, a color correction method may include: receiving a first reference image generated by photographing a first object in a first lighting condition using a reference camera; receiving a first image generated by photographing the first object in the first lighting condition using a first camera; calculating a first color correction matrix of the first camera using the first reference image, the first image, and a first reference color correction matrix of the reference camera, the first color correction matrix and the first reference color correction matrix corresponding to the first lighting condition; receiving a first actual image generated by photographing a second object in the first lighting condition using the first camera; and correcting the first actual image using the first color correction matrix. The first object may be the same as or different from the second object.

An electronic device may include at least one processor configured to execute the method.

A non-transitory computer-readable storage medium may store a computer program that, when executed by at least one processor, the method is implemented.

According to one or more example embodiments, a color correction method may include: receiving a first reference image generated by photographing a first object in a first lighting condition using a reference camera; receiving a first image generated by photographing the first object in the first lighting condition using a first camera; calculating a first color correction matrix of the first camera using the first reference image, the first image, and a first reference color correction matrix of the reference camera, the first color correction matrix and the first reference color correction matrix corresponding to the first lighting condition, by determining the first color correction matrix such that a difference between the first image corrected using the first color correction matrix and the first reference image corrected using the first reference color correction matrix is minimized; receiving a first actual image generated by photographing a second object in the first lighting condition using the first camera; and correcting the first actual image using the first color correction matrix. The first object may be the same as or different from the second object.

Another aspects and/or advantages of the present invention conception will be partially described in the following description, and part will be clear through the description or may be learn through the practice of various example embodiments.

### BRIEF DESCRIPTION OF THE DRAWINGS

The above and other objects, features and advantages of the present disclosure will become clearer through the following detailed description together with the accompanying drawings in which:

FIG. 1 is a flowchart illustrating a method of determining a color correction matrix according to one or more embodiments;

FIG. 2 is a flowchart illustrating a method of determining a color correction matrix according to one or more embodiments;

FIG. 3 is a flowchart illustrating a method of determining a color correction matrix according to one or more embodiments;

FIG. 4 is a flowchart illustrating a method of determining a color correction matrix according to one or more embodiments;

FIG. 5 is a flowchart illustrating a method of determining a spectral response function according to one or more embodiments;

FIG. 6 is a flowchart illustrating a method of determining a color correction matrix according to one or more embodiments;

FIG. 7 is a flowchart illustrating a color correction method according to one or more embodiments;

FIG. 8 is a flowchart illustrating a method of determining a color correction matrix according to one or more embodiments; and

FIG. 9 is a block diagram illustrating an electronic device according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical or scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

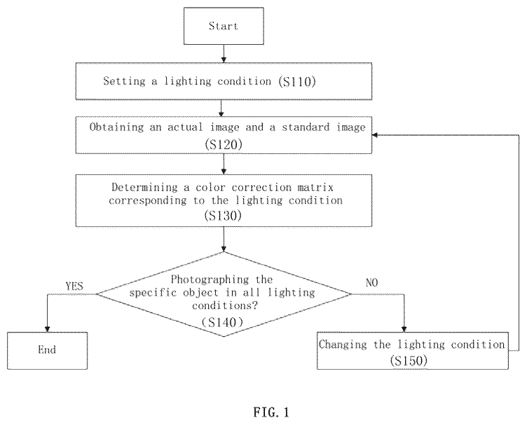

FIG. 1 is a flowchart illustrating a method of determining a color correction matrix according to one or more embodiments.

As is shown in FIG. 1, in operation S110, a lighting condition may be set.

In operation S120, a specific object (e.g., a standard color card) may be photographed using a first camera in the set lighting condition to obtain an actual image, and a standard image corresponding to the set lighting condition may be obtained.

In operation S130, the actual image may be compared to the standard image, and a color correction matrix (CCM), corresponding to the set lighting condition, of the first camera may be determined based on the comparison result. Typically, it may take several hours to perform operation S130.

In operation S140, whether the first camera photographs the specific object in all lighting conditions may be determined.

When it is determined that the first camera does not photograph the specific object in all lighting conditions (NO in operation S140), in operation S150, the lighting condition may be changed to select unused lighting conditions from among all lighting conditions, and after operation S150, the processing may proceed to operation S120.

When it is determined that the first camera photographs the specific object in all lighting conditions (YES in operation S140), the processing of determining the color correction matrix may end.

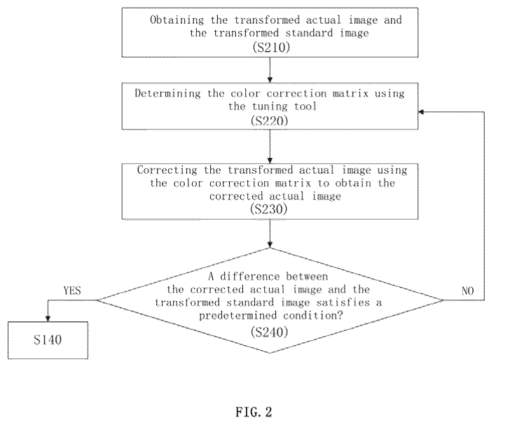

FIG. 2 is a flowchart illustrating a method of determining a color correction matrix according to one or more embodiments. FIG. 2 is a detailed description of operation S130 of FIG. 1.

As shown in FIG. 2, in operation S210, a color space transformation may be performed on the actual image to obtain the transformed actual image, and the color space transformation may be performed on the standard image to obtain the transformed standard image.

In operation S220, a color correction matrix may be determined using the tuning tool based on the transformed actual image and the transformed standard image.

In operation S230, the transformed actual image may be corrected using the color correction matrix to obtain the corrected actual image.

In operation S240, it may be determined whether a difference between the corrected actual image and the transformed standard image satisfies a predetermined condition.

When it is determined that the difference between the corrected actual image and the transformed standard image does not satisfy the predetermined condition (NO in operation S240), the processing may proceed to operation S220.

When it is determined that the difference between the corrected actual image and the transformed standard image satisfies the predetermined condition (YES in operation S240), the processing may proceed to operation S140.

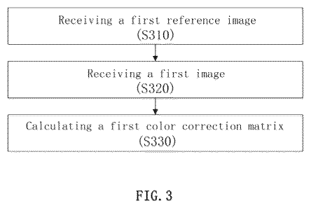

FIG. 3 is a flowchart illustrating a method of determining a color correction matrix according to one or more embodiments. FIG. 3 is a flowchart illustrating a method of determining a color correction matrix corresponding to a first lighting condition.

As illustrated in FIG. 3, in operation S310, a first reference image generated through photographing a first object in a first lighting condition by a reference camera may be received.

In the present application, a first camera may represent a camera to be calibrated or corrected, and the reference camera may represent a camera as a target for which the first camera is calibrated.

According to one or more embodiments, the first lighting condition may represent a standard lighting condition in which illumination on each region of the first object is uniform.

According to one or more embodiments, the first object may be a standard color card (e.g., a 24-patch-color card, a 140-patch-color card, etc.) used to calibrate the camera.

In an example, the first reference image may also be determined in advance (e.g., may be determined before determining, for adjusting the color consistency between the first camera and the reference camera, the color correction matrix of the first camera).

In operation S320, a first image generated through photographing the first object in the first lighting condition by the first camera may be received.

In operation S330, a first color correction matrix, corresponding to the first lighting condition, of the first camera, may be calculated using the first reference image, the first image, and a first reference color correction matrix, corresponding to the first lighting condition, of the reference camera.

Hereinafter, an ith reference color correction matrix may represent a color correction matrix that may be used to correct an image captured in an ith lighting condition by the reference camera, and an ith color correction matrix may represent a color correction matrix that may be used to correct an image captured in the ith lighting condition by the first camera.

According to one or more embodiments, a reference color correction matrix, corresponding to each lighting condition, of the reference camera may be determined and stored in advance.

According to one or more embodiments, the first color correction matrix may be determined such that a difference between the first image corrected by the first color correction matrix and the first reference image corrected by the first reference color correction matrix is minimized.

In an example, the first color correction matrix may be determined using an iterative approach (e.g., using a gradient descent method, a Quasi-Newton method, etc.). For example, the first color correction matrix may be determined such that a difference between a first computation matrix and a first reference matrix is minimized. For example, the first computational matrix may represent a matrix determined by applying a first intermediate matrix obtained by multiplying the first color correction matrix by a first RGB matrix of the first image to a predetermined conversion function. For example, the first reference matrix may represent a matrix determined by applying a first reference intermediate matrix obtained by multiplying the first reference color correction matrix by a first reference RGB matrix of the first reference image to the predetermined conversion function.

For example, the first color correction matrix may be determined by following Equation 1.

$${T}_{s} = \begin{matrix}arg min \\ {T}_{s}\end{matrix} {‖ f ( {C}_{s} {T}_{s} ) - f ( {C}_{t} {T}_{t} ) ‖}_{2} \qquad ( Equation 1 )$$

In Equation 1, Tₛ may represent the first color correction matrix; Cₛ may represent the first RGB matrix (in an example, Cₛ may be a matrix of N×3, wherein N may be a number of patches of the first object); Tt may represent the first reference color correction matrix; Cₜ may represent the first reference RGB matrix; I*I₂ denotes a 2-norm; and f( ) may represent the predetermined conversion function used to convert a perceptual space of a camera into the human eye's perceptual space.

For example, each of Tₛ and Tt includes a plurality of correction matrices corresponding to a plurality of colors, respectively (in an example, each correction matrix of the plurality of correction matrices may be a matrix of 3×3).

For example, f( ) may be a linear function or a nonlinear function. In an example, when f( ) is implemented with the linear function, the perceptual space of the camera may be maintained but it is beneficial to reduce the computational complexity; and when f( ) is implemented with the non-linear function, the human eye's perceptual space may be approached but the computational complexity may be increased.

In another example, the first color correction matrix may be determined by correcting the first reference color correction matrix using a first correction term reflecting the first RGB matrix of the first image and the first reference RGB matrix of the first reference image.

For example, the first color correction matrix may be determined by multiplying the first correction term by the first reference color correction matrix, and by the first color correction matrix thus determined, the difference between the first image corrected by the first color correction matrix and the first reference image corrected by the first reference color correction matrix may be minimized.

For example, the first correction term may represent a product of an inverse of a product of a first transpose matrix of the first RGB matrix and the first RGB matrix, the first transpose matrix and the first reference RGB matrix.

According to one or more embodiments, the predetermined conversion function f( ) of Equation 1 may be implemented by using a constant function, and in this case, the first correction term and the first color correction matrix corresponding to the first lighting condition may be computed using following Equation 2.

$${T}_{s} = \begin{matrix}arg min \\ {T}_{s}\end{matrix} {‖ {C}_{s} {T}_{s} - {C}_{t} {T}_{t} ‖}_{2} = {( {C}_{s}^{T} {C}_{s} )}^{- 1} {C}_{s}^{T} {C}_{t} {T}_{t} \qquad ( Equation 2 )$$

In Equation 2, (Cₛ^{T}Cₛ)⁻¹Cₛ^{T}Cₜ may represent the first correction term.

Compared to determining the color correction matrix by the tuning tool, in the present application, it may take less time to calculate or determine the color correction matrix, corresponding to the standard lighting condition, of the first camera (e.g., because the calculating may be performed by a computing device), thereby improving the efficiency of determining the color correction matrix.

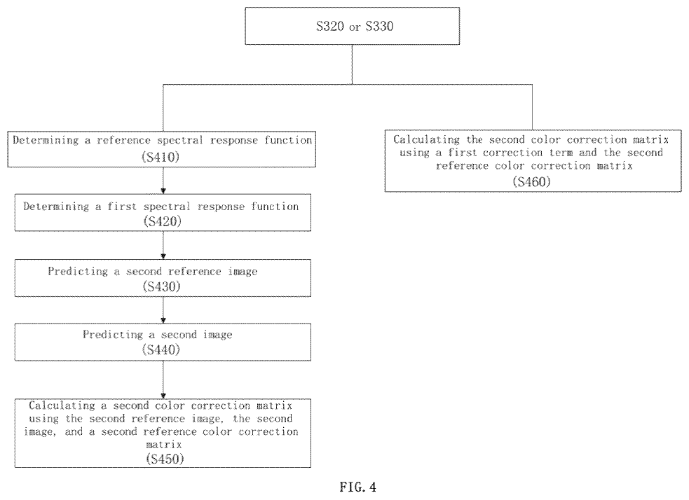

FIG. 4 is a flowchart illustrating a method of determining a color correction matrix according to one or more embodiments. FIG. 4 is a flowchart illustrating a method of determining color correction matrices corresponding to remaining lighting conditions except the first lighting condition.

As illustrated in FIG. 4, after receiving the first reference image and the first image (e.g., after operation S320 or operation S330), in operation S410, a reference spectral response function of the reference camera may be determined.

Hereinafter, the reference spectral response function may represent a spectral response function, a spectral sensitivity, or a spectral response matrix of the reference camera. In an example, the reference spectral response function may be determined in advance.

In operation S420, a first spectral response function of the first camera may be determined.

Hereinafter, the first spectral response function may represent a spectral response function, a spectral sensitivity, or a spectral response matrix of the first camera.

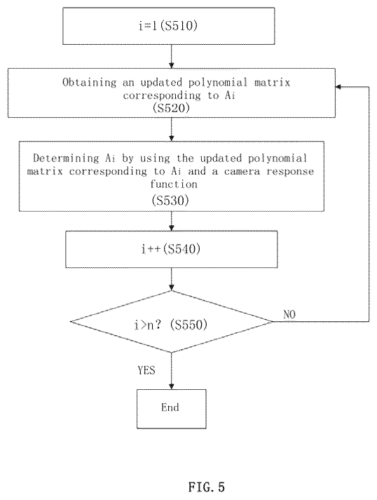

According to one or more embodiments, the first spectral response function may be determined in the same manner as the manner of determining the reference spectral response function. The processing of determining the spectral response function (e.g., the reference spectral response function or the first spectral response function) will be described in detail with reference to FIG. 5.

In operation S430, a second reference image, corresponding to a second lighting condition, of the reference camera may be predicted, using the reference spectral response function.

According to one or more embodiments, the second lighting condition may be different from the first lighting condition, and the second lighting condition may be one of lighting conditions except the first lighting condition.

According to one or more embodiments, the processing of predicting the second reference image may represent predicting an image that may be generated through photographing the first object in the second lighting condition by the reference camera, rather than actually photographing the first object in the second lighting condition using the reference camera, thereby reducing time costs and labor costs. In an example, the second reference image may be determined in advance.

According to one or more embodiments, the second reference image may be computed by applying a spectral reflectance matrix of the first object, a second spectral power distribution corresponding to the second lighting condition, and the reference spectral response function to a camera response function (e.g., Equation 3 below).

For example, the camera response function may reflect (be based on) a relationship between a RGB matrix of an image, corresponding to a lighting condition, of a camera and a spectral reflectance matrix of an object photographed by the camera, a spectral power distribution corresponding to the lighting condition, and a spectral response function of the camera.

In an example, the camera response function may be represented as the following Equation 3.

$$C = R L S \qquad ( Equation 3 )$$

In Equation 3, C may represent the image, corresponding to the lighting condition, of the camera, R may represent a spectral reflectance matrix of the object photographed by the camera, L may represent a diagonal matrix of the spectral power distribution corresponding to the lighting condition, and S may represent the spectral response function of the camera.

In this case, the second reference image may be calculated or determined by determining R of Equation 3 as the spectral reflectance matrix of the first object, determining L as the diagonal matrix of the second spectral power distribution corresponding to the second lighting condition, and determining S as the reference spectral response function. For example, the second reference image may be calculated or determined as shown in Equation 4 below.

$${C}_{t}^{′} = R {L}^{′} {S}_{t} \qquad ( Equation 4 )$$

In Equation 4, Cₜ′ may represent the second reference image, L′ may represent the diagonal matrix of the second spectral power distribution corresponding to the second lighting condition, and St may represent the reference spectral response function.

That is, the second reference image may be calculated by multiplying the spectral reflection matrix of the first object, the diagonal matrix of the second spectral power distribution corresponding to the second lighting condition, and the reference spectral response function.

In addition, examples of the camera response function are not limited to Equation 3 above, and any camera response function that can reflect the relationship between a RGB matrix of an image, corresponding to a lighting condition, of a camera and a spectral reflectance matrix of an object photographed by the camera, a spectral power distribution corresponding to the lighting condition, and a spectral response function of the camera may be used.

In operation S440, a second image, corresponding to the second lighting condition, of the first camera may be predicted, using the first spectral response function.

Similarly, the processing of predicting the second image may represent predicting an image that may be generated through photographing the first object in the second lighting condition by the first camera, rather than actually photographing the first object in the second lighting condition using the first camera, thereby reducing time costs and labor costs.

According to one or more embodiments, the second image may be calculated or determined by determining R of Equation 3 as the spectral reflectance matrix of the first object, determining L as the diagonal matrix of the second spectral power distribution corresponding to the second lighting condition, and determining S as the first spectral response function. For example, the second image may be calculated as shown in Equation 5 below . . .

$${C}_{s}^{′} = R {L}^{′} {S}_{s} \qquad ( Equation 5 )$$

In Equation 5, Cₛ′ may represent the second image and Ss may represent the first spectral response function.

That is, the second image may be calculated by multiplying the spectral reflection matrix of the first object, the diagonal matrix of the second spectral power distribution corresponding to the second lighting condition, and the first spectral response function.

In operation S450, a second color correction matrix, corresponding to the second lighting condition, of the first camera, may be calculated using the second reference image, the second image, and a second reference color correction matrix, corresponding to the second lighting condition, of the reference camera.

According to one or more embodiments, the second color correction matrix may be determined such that a difference between the second image corrected by the second color correction matrix and the second reference image corrected by the second reference color correction matrix is minimized.

In an example, the second color correction matrix may be determined using the iterative approach (e.g., using the gradient descent method, the Quasi-Newton method, etc.). For example, the second color correction matrix may be determined such that a difference between a second computation matrix and a second reference matrix is minimized. For example, the second computational matrix may represent a matrix determined by applying a second intermediate matrix obtained by multiplying the second color correction matrix by a second RGB matrix of the second image to the predetermined conversion function. For example, the second reference matrix may represent a matrix determined by applying a second reference intermediate matrix obtained by multiplying the second reference color correction matrix by a second reference RGB matrix of the second reference image to the predetermined conversion function.

Compared to determining the color correction matrix corresponding to each lighting condition by the tuning tool, in the present application, images, corresponding to the remaining lighting conditions, of the reference camera and the first camera are predicted by using spectral response functions of the reference camera and the first camera, and color correction matrices, corresponding to the remaining lighting conditions, of the first camera is calculated using the predicted images, which may reduce the time for photographing the first object in the remaining light conditions, thereby further improving the efficiency of determining the color correction matrix.

Although the processing of predicting the second reference image and the second image is described above, the examples are not limited thereto, and it is also possible to receive, when calculating the second color correction matrix, the second reference image generated through photographing the first object in the second lighting condition by the reference camera and the second image generated through photographing the first object in the second lighting condition by the first camera.

According to another embodiment, in operation S460, the second color correction matrix may be determined by correcting the second reference color correction matrix using the above-described first correction term. That is, when determining the second color correction matrix, operations S410 to S450 or operation S460 may be performed.

For example, the second color correction matrix may be determined by multiplying the first correction term by the second reference color correction matrix, and by the second color correction matrix thus determined, the difference between the second image corrected by the second color correction matrix and the second reference image corrected by the second reference color correction matrix may be minimized.

Compared to determining the color correction matrix corresponding to each lighting condition by the tuning tool, in the present application, the color correction matrices, corresponding to the remaining lighting conditions, of the first camera is calculated by using the simple first correction term corresponding to the first lighting condition, which may reduce the complexity of calculating the color correction matrix and reduce the time for photographing the first object in the remaining lighting conditions, thereby further improving the efficiency of determining the color correction matrix.

FIG. 5 is a flowchart illustrating a method of determining a spectral response function according to one or more embodiments.

The processing of determining the reference spectral response function of the reference camera is similar to the processing of determining the first spectral response function of the first camera, and thus, the processing of determining the reference spectral response function of the reference camera described below may be equally applied to the processing of determining the first spectral response function of the first camera.

According to one or more embodiments, the reference spectral response function may be a polynomial matrix using the first reference RGB matrix of the first reference image as a variable. For example, the polynomial matrix may be represented as following Equation 6.

$${S}_{t} = {A}_{1} {C}_{t}^{1} + {A}_{2} {C}_{t}^{2} + … + {A}_{n} {C}_{t}^{n} + O ( {C}_{t}^{n} ) \qquad ( Equation 6 )$$

In Equation 6, St may represent the reference spectral response function (in and example, St may be a matrix of M×3, wherein M may represent a number of sampling points in a spectral wavelength dimension); Cₜⁱ may represent an ith-order response matrix of the reference image; and Aᵢ may represent an ith-order coefficient matrix. How to determine the coefficient matrix will be described in detail below. In an example, a residual term O(Cₜⁿ) may be ignored when determining the coefficient matrix.

According to one or more embodiments, Cₜ may be a matrix of N×3, and N represents the number of the patches of the first object (e.g., the standard color card). For example, Cₜ may include a plurality of elements (e.g., 3 elements (e.g., a red component R, a green component G, and a blue component B)) corresponding to each of the plurality of patches. The plurality of elements, corresponding to one patch, of Cₜ may include an average of a plurality of red components R of a plurality of pixel values, corresponding to the one patch, of the first reference image, an average of a plurality of green components G of the plurality of pixel values, and an average of a plurality of blue components of the plurality of pixel values.

In an example, each of the plurality of elements, corresponding to one patch, of Cₜⁱ may represent the ith power of a corresponding element of the plurality of elements, corresponding to the one patch, of Cₜ. That is, Cₜⁱ may represent a matrix constituted by the ith power of each element of Cₜ.

In another example, each of the plurality of elements, corresponding to one patch, of Cₜⁱ may represent a monomial constituted by at least one of the plurality of elements, corresponding to the one patch, of Cₜ.

As shown in FIG. 5, in operation S510, a variable i may be set to 1.

In operation S520, an updated polynomial matrix corresponding to an ith-order coefficient matrix may be obtained.

For example, an updated polynomial matrix corresponding to a 1st-order coefficient matrix A₁ may be obtained by setting a 2^{nd}-order coefficient matrix A₂ to an nth-order coefficient matrix Aₙ of an original polynomial matrix to a zero matrix.

For example, an updated polynomial matrix corresponding to an mth-order coefficient matrix Aₘ may be obtained by substituting the previously determined 1st-order coefficient matrix A₁ to (m−1)th-order coefficient matrix Aₘ₋₁ into the original polynomial matrix and setting an (m+1)-order coefficient matrix Aₘ₊₁ to the nth-order coefficient matrix Aₙ of the original polynomial matrix to the zero matrix, m being an integer greater than 1 and less than n.

For example, an updated polynomial matrix corresponding to the nth-order coefficient matrix Aₙ may be obtained by substituting the previously determined 1st-order coefficient matrix A₁ to (n−1)th-order coefficient matrix Aₙ₋₁ into the original polynomial matrix.

In the original polynomial matrix, the 1st order coefficient matrix to the nth order coefficient matrix are not determined.

In operation S530, the ith-order coefficient matrix may be determined, by using the updated polynomial matrix corresponding to the ith-order coefficient matrix and the camera response function.

For example, the ith-order coefficient Aᵢ may be calculated by substituting the updated polynomial matrix Sₜ=A₁Cₜ¹+A₂Cₜ²+ . . . +AᵢCₜⁱ into a camera response function (e.g., Cₜ=RLSₜ, wherein L may represent a diagonal matrix of a first spectral power distribution corresponding to the first lighting condition) reflecting a relationship between the first reference RGB matrix and the spectral reflectance matrix of the first object, the first spectral power distribution corresponding to the first lighting condition, and the reference spectral response function.

In operation S540, the variable i may be increased by 1.

In operation S550, it may be determined whether the variable i is greater than n.

When the variable i is less than or equal to n (NO in operation S550), the processing may proceed to operation S520.

When the variable i is greater than n (YES in operation S550), the processing may end.

According to one or more embodiments, the 1st-order coefficient matrix A₁ of a first term A₁Cₜ¹ to the nth-order coefficient matrix Aₙ of an nth term of the polynomial matrix may be determined in an order from the 1^{st}-order coefficient matrix A₁ to the nth-order coefficient matrix Aₙ.

In an example, when determining the 1^{st}-order coefficient matrix A₁, the 2^{nd}-order coefficient matrix A₂ to the nth-order coefficient matrix Aₙ of the original polynomial matrix may be set to the zero matrix, thereby obtaining the updated polynomial matrix Sₜ=A₁Cₜ¹.

Equation 7 below may be obtained by substituting the updated polynomial matrix into Sₜ=A₁Cₜ¹ into the camera response function (Cₜ=RLSₜ) described above.

$${C}_{t} = R L {A}_{1} {C}_{t}^{1} \qquad ( Equation 7 )$$

According to Equation 7, the 1^{st}-order coefficient matrix A₁ may be computed as shown in Equation 8 below.

$${A}_{1} = {[ {( R L )}^{T} ( R L ) + λ ( {D}^{T} D ) ]}^{- 1} {( R L )}^{T} \qquad ( Equation 8 )$$

In Equation 8, 2 may represent an adjustable regularization coefficient; and D may represent a predetermined discrete 2^{nd}-order derivative operator matrix (e.g., a discrete Laplace operator matrix).

When determining the 2^{nd}-order coefficient matrix A₂, an updated polynomial matrix Sₜ=A₁Cₜ¹+A₂Cₜ² may be obtained by substituting the previously determined 1^{st}-order coefficient matrix A₁ into the original polynomial matrix and setting a 3rd-order coefficient matrix A₃ to the nth-order coefficient matrix Aₙ to the zero matrix.

The updated polynomial matrix Sₜ=A₁Cₜ¹+A₂Cₜ² may be substituted into the camera response function (Cₜ=RLSₜ) described above, and the 2^{nd}-order coefficient matrix A₂ may be computed as shown in Equations 9 and 10 below.

$${A}_{2} = {[ {( R L )}^{T} ( R L ) + {λ}_{2} ( ( {D}^{T} ) ( D ) ) ]}^{- 1} {( R L )}^{T} {Δ}_{1} {{C}_{t}^{{2}^{T}} ( {C}_{t}^{2} {C}_{t}^{{2}^{T}} )}^{- 1} \qquad ( Equation 9 )$$

$${Δ}_{1} = {C}_{t} - R L {A}_{1} {C}_{t}^{1} \qquad ( Equation 10 )$$

In Equation 9, 22 may represent an adjustable regularization coefficient.

In addition, the coefficient matrices A₃ to Aₙ may be determined in a similar manner.

In the present application, by using the polynomial matrix to represent the spectral response functions of the reference camera and the first camera, complex instruments (such as a monochromator) for determining the spectral response functions may be avoided, and it may be more conveniently to determine the spectral response functions of the reference camera and the first camera and the time for photographing the first object in the remaining lighting conditions may be decreased, thereby further improving the efficiency of determining the color correction matrices. Additionally, by using the polynomial matrix to approximate the spectral response functions of the reference camera and the first camera, the error in the estimated spectral response functions may be reduced, and the accuracy of estimating the spectral response functions may be improved.

Although a way of determining the spectral response function using the polynomial matrix is shown above, the present disclosure is not limited thereto and other existing ways of determining the spectral response functions may also be used.

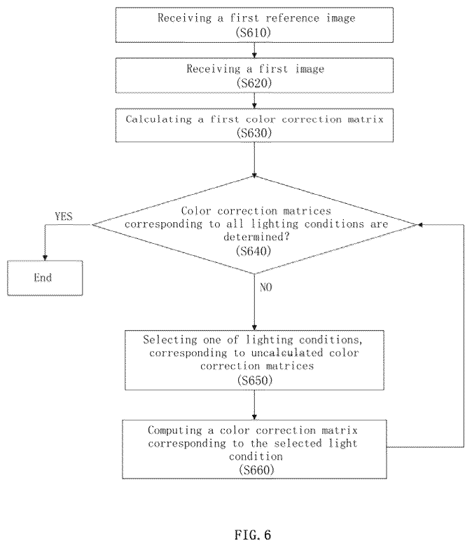

FIG. 6 is a flowchart illustrating a method of determining a color correction matrix according to one or more embodiments.

As shown in FIG. 6, in operation S610, a first reference image generated through photographing a first object in a first lighting condition by a reference camera may be received.

In operation S620, a first image generated through photographing the first object in the first lighting condition by a first camera may be received.

In operation S630, a first color correction matrix corresponding to the first lighting condition may be determined.

In operation S640, it may be determined whether color correction matrices, corresponding to all lighting conditions, of the first camera are determined.

When the color correction matrices, corresponding to all lighting conditions, of the first camera are determined (YES in operation S640), the processing may end.

When the color correction matrices, corresponding to all lighting conditions, of the first camera have not been determined (NO in operation S640), in operation S650, one of lighting conditions, corresponding to uncalculated color correction matrices, among all lighting conditions may be selected.

In operation S660, a color correction matrix corresponding to the selected light condition may be determined.

For example, the color correction matrices in operation S630 and operation S660 may be determined (e.g., using the first correction term described above) in the case that the predetermined conversion function is implemented as the constant function. For another example, the color correction matrices in the operation S630 and the operation S660 may be determined (e.g., using the iterative approach) in a case that the predetermined conversion function is implemented as a function except the constant function. Thereafter, processing may proceed to operation S640.

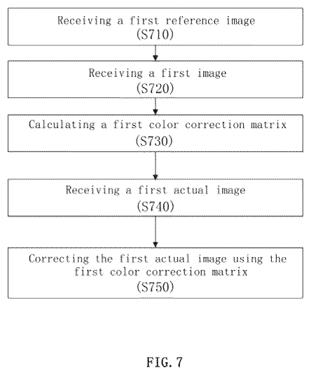

FIG. 7 is a flowchart illustrating a color correction method according to one or more embodiments.

Operation S710, operation S720, and operation S730 of FIG. 7 may be similar to operation S310, operation S320, and operation S330 of FIG. 3, and thus, detailed description thereof will be omitted to avoid redundancy.

In operation S740, a first actual image generated through photographing a second object in the first lighting condition by the first camera may be received.

According to one or more embodiments, the second object may be the same as or different from the first object. In an example, the second object may be an object photographed by the first camera when working actually.

In operation S750, the first actual image may be corrected using the first color correction matrix. For example, the first actual image may be corrected by multiplying the first color correction matrix by a first actual RGB matrix of the first actual image.

In addition, the second color correction matrix described above with reference to FIGS. 4 and 5 may also be used to correct an actual image generated in the second lighting condition by the first camera.

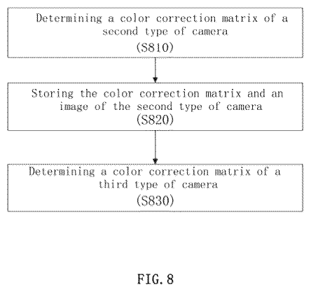

FIG. 8 is a flowchart illustrating a method of determining a color correction matrix according to another example embodiment.

As illustrated in FIG. 8, in operation S810, a color correction matrix, corresponding to each lighting condition, of a second type of camera (e.g., a golden module of cameras to be corrected) may be determined by using a first type of camera (e.g., a golden module of reference cameras) as the reference camera and the second type of camera as the first camera.

According to one or more embodiments, the color correction matrix, corresponding to each lighting condition, of the second type of camera may be determined using the method of determining the color correction matrix described with reference to FIGS. 3 to 6. In an example, the color correction matrix, corresponding to each lighting condition, of the second type of camera may be adjusted again according to requirements (e.g., tendencies and preferences, etc.) of a customer, after determining the color correction matrix, corresponding to each lighting condition, of the second type of camera using the method of determining the color correction matrix described with reference to FIGS. 3 to 6.

In operation S820, the color correction matrix and an image (including an image obtained through photographing the first object in the first lighting condition by the second type of camera and predicted images, corresponding to the remaining lighting conditions, of the second type of camera), corresponding to each lighting condition, of the second type of camera may be stored.

For example, the color correction matrix and the image, corresponding to each lighting condition, of the second type of camera may be stored in a non-volatile memory device (e.g., electrically erasable programmable read-only memory (EEPROM), but not limited thereto).

In operation S830, a color correction matrix, corresponding to each lighting condition, of a third type of camera (e.g., a non-golden module of the cameras to be corrected) may be determined by using the second type of camera as the reference camera and using the third type of camera as the first camera.

According to one or more embodiments, the color correction matrix, corresponding to each lighting condition, of the third type of camera may be determined using the method of determining the color correction matrix described with reference to FIGS. 3 to 6.

In an example, the color correction matrix of the second type of camera may be calculated (e.g., via a computer of the tester) before it begins to work, and the color correction matrix of the third type of camera may be calculated either (e.g., via the computer of the tester) before it begins to work or (e.g., via a processor of an electronic device where it is located) while it is working.

Compared to determining only the color correction matrix of the second type of camera and using the determined color correction matrix as the color correction matrix of the third type of camera, in the present application, the color correction matrix of the third type of camera may be determined by using the second type of camera as the reference camera and using the third type of camera as the first camera, and thus the color correction matrix suitable for the non-golden module of the cameras to be corrected may be determined, thereby improving the quality of the camera calibration.

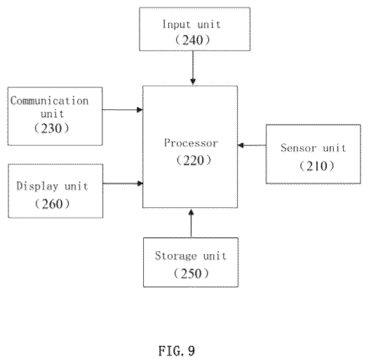

FIG. 9 is a block diagram illustrating an electronic device according to some one or more embodiments.

As shown in FIG. 9, the electronic device 200 in some one or more embodiments includes a sensor unit 210, at least one processor 220, a communication unit 230, an input unit 240, a storage unit 250, and a display unit 260.

The sensor unit 210 is connected to the processor 220. The processor 220 may perform the method of determining the color correction matrix and the color correction matrix described with reference to FIGS. 3 to 6 above.

The communication unit 230 performs a communication operation of the electronic device. The communication unit 230 may establish a communication channel to the communication network and/or may perform communication associated with, for example, image processing.

The input unit 240 is configured to receive various input information and various control signals, and transmit the input information and control signals to the processor 220. The input unit 240 may be realized by various input devices such as touch screens, etc.; however, the one or more embodiments are not limited thereto.

The storage unit 250 may include volatile memory and/or nonvolatile memory. The storage unit 250 may store various data generated and used by the electronic device. For example, the storage unit 250 may store an operating system and applications (e.g. applications associated with the method of the present disclosure) for controlling the operation of the electronic device. The processor 220 may control the overall operation of the electronic device and may control part or all of the internal elements of the electronic device The processor 220 may be implemented as general-purpose processor, application processor (AP), application specific integrated circuit, field programmable gate array, etc., but the one or more embodiments are not limited thereto.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In an example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples plurality of processors or computers may be used, or a processor or computer may include plurality of processing elements, or plurality of types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction plurality of-data (SIMD) multiprocessing, plurality of-instruction single-data (MISD) multiprocessing, and plurality of-instruction plurality of-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions or software include machine code that is directly executed by the processor or computer, such as machine code produced by a compiler. In another example, the instructions or software include higher-level code that is executed by the processor or computer using an interpreter. Programmers of ordinary skill in the art may readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

While this disclosure includes specific examples, it will be apparent to one of ordinary skill in the art that various changes in form and details may be made in these examples without departing from the spirit and scope of the claims and their equivalents.

What is claimed is:

1. A method of determining a color correction matrix comprising:
receiving a first reference image generated by photographing a first object in a first lighting condition using a reference camera;
receiving a first image generated by photographing the first object in the first lighting condition using a first camera;
calculating a first color correction matrix of the first camera using the first reference image, the first image, and a first reference color correction matrix of the reference camera, the first color correction matrix and the first reference color correction matrix corresponding to the first lighting condition; and
correcting an actual image using the first color correction matrix.

2. The method of claim 1, wherein the calculating of the first color correction matrix corresponding to the first lighting condition of the first camera comprises: determining the first color correction matrix such that a difference between the first image corrected using the first color correction matrix and the first reference image corrected using the first reference color correction matrix is minimized.

3. The method of claim 2, wherein the determining of the first color correction matrix comprises: correcting the first reference color correction matrix using a first correction term reflecting a first RGB matrix of the first image and a first reference RGB matrix of the first reference image to determine the first color correction matrix.

4. The method of claim 1, further comprising:
calculating a second color correction matrix of the first camera corresponding to a second lighting condition, by correcting a second reference color correction matrix of the reference camera corresponding to the second lighting condition, using a first correction term reflecting a first RGB matrix of the first image and a first reference RGB matrix of the first reference image,
wherein the second lighting condition is different from the first lighting condition.

5. The method of claim 3, wherein the first correction term represents a product of a first transpose matrix, the first reference RGB matrix, and an inverse of a product of the first transpose matrix of the first RGB matrix and the first RGB matrix.

6. The method of claim 1, further comprising:
determining a reference spectral response function of the reference camera;
determining a first spectral response function of the first camera;
predicting a second reference image of the reference camera using the reference spectral response function, the second reference image corresponding to a second lighting condition;
predicting a second image of the first camera using the first spectral response function, the second image corresponding to the second lighting condition; and
calculating a second color correction matrix of the first camera using the second reference image, the second image, and a second reference color correction matrix of the reference camera, the second color correction matrix and the second reference color correction matrix corresponding to the second lighting condition,
wherein the second lighting condition is different from the first lighting condition.

7. The method of claim 6, wherein the reference spectral response function is a polynomial matrix which uses a first reference RGB matrix of the first reference image as a variable.

8. The method of claim 7,
wherein a 1^{st}-order coefficient matrix to a nth-order coefficient matrix of the polynomial matrix are determined in an order from the 1^{st}-order coefficient matrix to the nth-order coefficient matrix,
wherein an ith-order coefficient matrix of the polynomial matrix is determined by:
obtaining an updated polynomial matrix corresponding to the ith-order coefficient matrix; and
determining the ith-order coefficient matrix, by using the updated polynomial matrix corresponding to the ith-order coefficient matrix and a camera response function,
wherein n is an integer greater than 1, and i is an integer greater than or equal to 1 and less than or equal to n,
wherein an updated polynomial matrix corresponding to the 1^{st}-order coefficient matrix is obtained by setting a 2^{nd}-order coefficient matrix to the nth-order coefficient matrix of an original polynomial matrix to a zero matrix,
wherein an updated polynomial matrix corresponding to an mth-order coefficient matrix is obtained by substituting the previously determined 1^{st}-order coefficient matrix to (m−1)th-order coefficient matrix into the original polynomial matrix and setting an (m+1)-order coefficient matrix to the nth-order coefficient matrix of the original polynomial matrix to the zero matrix, m being an integer greater than 1 and less than n,
wherein an updated polynomial matrix corresponding to the nth-order coefficient matrix is obtained by substituting the previously determined 1^{st}-order coefficient matrix to (n−1)th-order coefficient matrix into the original polynomial matrix, and
wherein in the original polynomial matrix, the 1^{st}-order coefficient matrix to the nth-order coefficient matrix are not determined.

9. The method of claim 8, wherein the camera response function is based on a relationship between the first reference RGB matrix and a spectral reflectance matrix of the first object, a first spectral power distribution corresponding to the first lighting condition, and the reference spectral response function.

10. The method of claim 6, wherein the calculating of the second color correction matrix comprises: calculating the second color correction matrix such that a difference between the second image corrected using the second color correction matrix and the second reference image corrected using the second reference color correction matrix is minimized.

11. The method of claim 1, wherein the first lighting condition represents a standard lighting condition in which illumination on each region of the first object is uniform.

12. The method of claim 1, wherein the first object is a standard color card.

13. A color correction method comprising:
receiving a first reference image generated by photographing a first object in a first lighting condition using a reference camera;
receiving a first image generated by photographing the first object in the first lighting condition using a first camera;
calculating a first color correction matrix of the first camera using the first reference image, the first image, and a first reference color correction matrix of the reference camera, the first color correction matrix and the first reference color correction matrix corresponding to the first lighting condition;
receiving a first actual image generated by photographing a second object in the first lighting condition using the first camera; and
correcting the first actual image using the first color correction matrix,
wherein the first object is the same as or different from the second object.

14. An electronic device comprising:
at least one processor configured to execute the method of claim 1.

15. A non-transitory computer-readable storage medium storing a computer program that, when executed by at least one processor, the method of claim 1 is implemented.

16. A color correction method comprising:
receiving a first reference image generated by photographing a first object in a first lighting condition using a reference camera;
receiving a first image generated by photographing the first object in the first lighting condition using a first camera;
calculating a first color correction matrix of the first camera using the first reference image, the first image, and a first reference color correction matrix of the reference camera, the first color correction matrix and the first reference color correction matrix corresponding to the first lighting condition, by determining the first color correction matrix such that a difference between the first image corrected using the first color correction matrix and the first reference image corrected using the first reference color correction matrix is minimized;
receiving a first actual image generated by photographing a second object in the first lighting condition using the first camera; and
correcting the first actual image using the first color correction matrix,
wherein the first object is the same as or different from the second object.
